(19) United States
(12) Patent Application Publication
(10) Pub. No.: US 2012/0129212 A1
(43) Pub. Date: May 24, 2012

(54) METHOD OF MONITORING ERYTHROPOIESIS

(75) Inventor: Mark Wood, Scituate, MA (US)

(73) Assignee: VERTEX PHARMACEUTICALS INCORPORATED, CAMBRIDGE, MA (US)

(21) Appl. No.: 13/322,006

(22) PCT Filed: May 25, 2010
(86) PCT No.: PCT/US10/36063

§ 371 Date: Feb. 8, 2012

Related U.S. Application Data
(60) Provisional application No. 61/181,137, filed on May 26, 2009.

(51) Int. Cl. G01N 21/64

(52) U.S. Cl. 435/39

(57) ABSTRACT

The invention relates to methods of monitoring erythropoiesis. In particular, the invention relates to methods of detecting nascent erythrocyte production in vivo as methods for identifying modulators of erythropoiesis.

### CROSS-REFERENCE TO RELATED APPLICATION

This application claims priority to U.S. Provisional Application 61/181,137, filed May 26, 2009, which application is incorporated herein by reference in its entirety.

### FIELD OF THE INVENTION

The invention relates to methods of monitoring erythropoiesis. In particular, the invention relates to methods of detecting nascent erythrocyte production in vivo as well as methods for identifying modulators of erythropoiesis.

### BACKGROUND OF HE INVENTION

Erythropoiesis is the process by which the body produces new erythrocytes (red blood cells). Erythrocytes undergo steady-state turnover with 1% in humans (2.5% in mice) of erythrocytes being renewed per day. Erythropoietin (EPO), a naturally-occurring hormone that stimulates erythropoiesis, maintains homeostasis by ensuring that erythrocyte formation occurs at the same rate as erythrocyte loss. Decreased blood oxygen levels cause the kidney to release more EPO into the blood stream to produce more hemoglobin containing erythrocytes to transport oxygen in the blood. This mechanism allows for increased erythropoiesis following erythrocyte loss due to injury or disease.

Modulators of erythropoiesis are useful in treating erythrocyte-related diseases, such as anemia and polycythemia vera. Standard methods of measuring erythropoiesis (in mice) are used to determine the efficacy of such modulators in vivo. These methods include measuring hematocrit, reticulocytes, erythroid blast forming units (BFU-E), colony forming units (CFU-E), incorporation of radioactive iron into splenocytes, or TER-119(+) erythroid cells by immunostaining and flow-cytometry.

However, all of the standard methods of quantifying erythropoiesis are met with severe limitations. For instance, hematocrit, reticulocyte, and progenitor measurements require the collection of substantial quantities of blood. Additionally, BFU-E, CFU-E, and radioactive iron uptake are all terminal procedures. None of the standard methods of measuring the in vivo efficacy of erythropoiesis modulators allows taking multiple samples from the same test animal to quantify erythropoiesis over time. A method that allows repeated measurements of erythropoiesis in a single subject over time would be beneficial for studying erythrocyte-related disease as well as modulators of erythropoiesis.

Accordingly, there is a need for novel methods of monitoring erythropoiesis as well new methods for identifying agents that modulate erythropoiesis.

### SUMMARY OF THE INVENTION

In accordance with a first aspect of the present invention, there is provided a method for detecting nascent erythrocyte production in vivo comprising the steps of: (a) obtaining one or more blood samples from a subject, the subject comprising a fluorescent protein; (b) determining a protein or activity level of the fluorescent protein in erythrocytes from the one or more samples; (c) comparing the protein or activity level of the fluorescent protein in the one or more samples to a protein or activity level of a control fluorescent protein, wherein an increase in the protein or activity level of the fluorescent protein in the one or more samples compared to the control is indicative of nascent erythrocyte production in vivo in the subject.

In accordance with a second aspect of the invention, there is provided a method for detecting erythrocyte age in vivo comprising the steps of (a) obtaining one or more blood samples from a subject, the subject comprising a fluorescent protein; (h) determining a protein or activity level of the fluorescent protein in erythrocytes from the one or more samples; (c) comparing the protein or activity level of the fluorescent protein in the one or more samples to a protein or activity level of a control fluorescent protein, wherein a decrease in the protein or activity level of the fluorescent protein in the one or more samples compared to the control is indicative of an increase in erythrocyte age in vivo in the subject.

In accordance with a third aspect of the invention, there is also provided a method for detecting erythrocyte turnover in vivo comprising the steps of (a) obtaining one or more blood samples from a subject, the subject comprising a fluorescent protein; (b) determining a protein or activity level of the fluorescent protein in erythrocytes from the one or more samples; (c) comparing the protein or activity level of the fluorescent protein in the one or more samples to a protein or activity level of a control fluorescent protein, wherein a change in the protein or activity level of the fluorescent protein in the one or more samples compared to the control is indicative of a change in erythrocyte turnover in vivo in the subject.

In some embodiments, the fluorescent protein is selected from the group consisting of green fluorescent protein (GFP), blue fluorescent protein (BFP), cyan fluorescent protein (CFP), yellow fluorescent protein (YFP), and red fluorescent protein (RFP). In particular embodiments, the fluorescent protein is GFP. In some embodiments, the fluorescent protein is expressed from a nucleic acid operatively linked to an expression control sequence.

In certain embodiments of the invention, the protein or activity level of the control fluorescent protein is the protein or activity level of a fluorescent protein in erythrocytes in a control blood sample from the subject prior to obtaining the one or more experimental samples. In certain embodiments of the invention, the blood samples from the subject are obtained repeatedly over time.

In some embodiments, the subject has suffered a blood loss, injury or disease. In some embodiments, the disease is polycythemia vera. In certain embodiments of the invention, the blood loss is associated with a condition selected from the group consisting of hemorrhage, acute blood loss, menstruation, anemia, hemophilia, hematoma, contusion, aneurysm, arteriovenous malformation, ulcerations, cancer, infection, thalassemia, Evans syndrome, spherocytosis and von Willebrand disease. In certain embodiments of the invention, the anemia is associated with a condition selected from the group consisting of chronic renal failure, end-stage renal disease, renal transplantation, cancer, acquired immune deficiency syndrome, chemotherapy, radiotherapy, bone marrow transplantation, prematurity, aplastic anemia, Fanconi anemia, hemolytic anemia, hereditary spherocytosis, sickle-cell anemia, auto-immune disease, pernicious anemia, myelophthisic anemia, pregnancy, Heinz body anemia, dimorphic anemia, normocytic anemia, macrocytic anemia, and microcytic anemia.

In certain embodiments of the invention, the subject is a mammal. In certain embodiments of the invention, the mammal is a mouse, rat, rabbit, or guinea pig. In certain embodiments of the invention, the mammal is a mouse.

In some embodiments, the subject comprises the fluorescent protein derived from exogenous cells.

In certain embodiments of the invention, the determining step utilizes an assay for measuring the fluorescence level of the fluorescent protein. In certain embodiments of the invention, the assay measures the fluorescence level of the fluorescent protein using flow cytometry. In certain embodiments of the invention, the flow cytometry is fluorescence activated cell sorting (FACS). In certain embodiments of the invention, the assay measures the fluorescence level of the fluorescent protein using fluorescent microscopy. In certain embodiments, the fluorescent microscopy is quantitative fluorescent microscopy or scanning fluorescent microscopy.

In accordance with a fourth aspect of the present invention, there is provided a method for identifying a modulator of erythropoiesis comprising the steps of: (a) exposing a test subject comprising a fluorescent protein to a test agent; (b) detecting a presence or absence of a change in the protein or activity level of the fluorescent protein in erythrocytes in the test subject compared to a subject comprising a fluorescent protein not exposed with the test agent; wherein the presence of a change in the protein or activity level of the fluorescent protein indicates that the test agent is a modulator of erythropoiesis.

In some embodiments, the protein or activity level of the fluorescent protein in erythrocytes is monitored by obtaining one or more blood samples.

In some embodiments, the fluorescent protein is selected from the group consisting of green fluorescent protein (GFP), blue fluorescent protein (BFP), cyan fluorescent protein (CFP), yellow fluorescent protein (YFP), and red fluorescent protein (RFP). In particular embodiments, the fluorescent protein is GFP. In some embodiments, the fluorescent protein is expressed from a nucleic acid operatively linked to an expression control sequence.

In certain embodiments of the invention, the protein or activity level of the fluorescent protein in the subject not exposed to the test agent is the protein or activity level of a fluorescent protein in erythrocytes from the test subject prior to exposure to the test subject.

In certain embodiments of the invention, the protein or activity level of the fluorescent protein in erythrocytes is monitored by obtaining one or more blood samples. In certain embodiments of the invention, the blood samples from the subject are obtained repeatedly over time.

In some embodiments, the subject has suffered a blood loss, injury or stress-induced erythropoiesis. In certain embodiments of the invention, the blood loss is associated with a condition selected from the group consisting of hemorrhage, acute blood loss, menstruation, hematoma, contusion, aneurysm, arteriovenous malformation, ulcerations, and infection.

In certain embodiments of the invention, the subject is a mammal. In certain embodiments of the invention, the mammal is a mouse, rat, rabbit, or guinea pig. In certain embodiments of the invention, the mammal is a mouse.

In certain embodiments of the invention, the detecting step utilizes an assay for measuring the fluorescence level of the fluorescent protein. In certain embodiments of the invention, the assay measures the fluorescence level of the fluorescent protein using flow cytometry. In certain embodiments of the invention, the flow cytometry is fluorescence activated cell sorting (FACS). In certain embodiments of the invention, the assay measures the fluorescence level of the fluorescent protein using fluorescent microscopy. In some embodiments, the fluorescent microscopy is quantitative fluorescent microscopy or scanning fluorescent microscopy.

In certain embodiments of the invention, the test agent is a small molecule, a chemical moiety, a polynucleotide, a polypeptide, or an antibody.

The invention also provides for a modulator identified by the any of the above methods.

In accordance with a fifth aspect of the present invention, there is provided a method for determining the efficacy of an agent in inhibiting erythropoiesis in vivo comprising the steps of: (a) exposing a test subject comprising a fluorescent protein to a test agent; (h) detecting a protein or activity level of the fluorescent protein in erythrocytes in the test subject and a protein or activity level of the fluorescent protein in erythrocytes in a subject comprising a fluorescent protein in the absence of the test agent; wherein a reduction in the protein or activity level of the fluorescent protein in the presence of the test agent compared to the protein or activity level of the fluorescent protein in the absence of the test agent indicates that the test agent is effective in inhibiting erythropoiesis.

In some embodiments, the protein or activity level of the fluorescent protein in erythrocytes is monitored by obtaining one or more blood samples. In certain embodiments of the invention, the blood samples from the subject are obtained repeatedly over time.

In some embodiments, the fluorescent protein is selected from the group consisting of green fluorescent protein (GFP), blue fluorescent protein (BFP), cyan fluorescent protein (CFP), yellow fluorescent protein (YFP), and red fluorescent protein (RFP). In particular embodiments, the fluorescent protein is GFP. In some embodiments, the fluorescent protein is expressed from a nucleic acid operatively linked to an expression control sequence.

In certain embodiments of the invention, the protein or activity level of the fluorescent protein in a subject in the absence of the test agent is the protein or activity level of a fluorescent protein in erythrocytes from the test subject prior to exposure to the test agent.

In some embodiments, the subject has suffered a blood loss, injury or stress-induced erythropoiesis. In certain embodiments of the invention, the blood loss is associated with a condition selected from the group consisting of hemorrhage, acute blood loss, menstruation, hematoma, contusion, aneurysm, arteriovenous malformation, ulcerations, and infection.

In certain embodiments of the invention, the subject is a mammal. In certain embodiments of the invention, the mammal is a mouse, rat, rabbit, or guinea pig. In certain embodiments of the invention, the mammal is a mouse.

In certain embodiments of the invention, the detecting step utilizes an assay for measuring the fluorescence level of the fluorescent protein. In certain embodiments of the invention, the assay measures the fluorescence level of the fluorescent protein using flow cytometry. In certain embodiments of the invention, the flow cytometry is fluorescence activated cell sorting (FACS). In certain embodiments of the invention, the assay measures the fluorescence level of the fluorescent protein using fluorescent microscopy. In some embodiments, the fluorescent microscopy is quantitative fluorescent microscopy or scanning fluorescent microscopy.

In certain embodiments of the invention, the test agent is a small molecule, a chemical moiety, a polynucleotide, a polypeptide, or an antibody. In certain embodiments of the invention, the test agent inhibits the erythropoietin signaling pathway. In certain embodiments of the invention, the test agent inhibits the Janus Kinase 2 (JAK2) signaling pathway.

In accordance with a sixth aspect of the present invention, there is provided a method of determining the efficacy of an agent in inducing erythropoiesis in vivo comprising the steps of: (a) exposing a test subject comprising a fluorescent protein to a test agent; (b) detecting a protein or activity level of said fluorescent protein in erythrocytes in the test subject and a protein or activity level of the fluorescent protein in erythrocytes in a subject comprising a fluorescent protein in the absence of the test agent; wherein an increase in the protein or activity level of the fluorescent protein in the presence of the test agent compared to the protein or activity level of the fluorescent protein in the absence of the test agent indicates that the test agent is effective in inducing erythropoiesis.

In some embodiments, the protein or activity level of the fluorescent protein in erythrocytes is monitored by obtaining one or more blood samples. In certain embodiments of the invention, the blood samples from the subject are obtained repeatedly over time.

In some embodiments, the fluorescent protein is selected from the group consisting of green fluorescent protein (GFP), blue fluorescent protein (BFP), cyan fluorescent protein (CFP), yellow fluorescent protein (YFP), and red fluorescent protein (RFP). In particular embodiments, the fluorescent protein is GFP. In some embodiments, the fluorescent protein is expressed from a nucleic acid operatively linked to an expression control sequence.

In certain embodiments of the invention, the protein or activity level of the fluorescent protein in a subject in the absence of the test agent is the protein or activity level of a fluorescent protein in erythrocytes from the test subject prior to exposure to the test agent.

In some embodiments, the subject has suffered a blood loss, injury or stress-induced erythropoiesis. In certain embodiments of the invention, the blood loss is associated with a condition selected from the group consisting of hemorrhage, acute blood loss, menstruation, hematoma, contusion, aneurysm, arteriovenous malformation, ulcerations, and infection.

In certain embodiments of the invention, the subject is a mammal. In certain embodiments of the invention, the mammal is a mouse, rat, rabbit, or guinea pig. In certain embodiments of the invention, the mammal is a mouse.

In certain embodiments of the invention, the detecting step utilizes an assay for measuring the fluorescence level of the fluorescent protein. In certain embodiments of the invention, the assay measures the fluorescence level of the fluorescent protein using flow cytometry. In certain embodiments of the invention, the flow cytometry is fluorescence activated cell sorting (FACS). In certain embodiments of the invention, the assay measures the fluorescence level of the fluorescent protein using fluorescent microscopy. In some embodiments, the fluorescent microscopy is Quantitative fluorescent microscopy or scanning fluorescent microscopy.

In certain embodiments of the invention, the test agent is a small molecule, a chemical moiety, a polynucleotide, a polypeptide, or an antibody. In certain embodiments of the invention, the test agent induces the erythropoietin signaling pathway.

### BRIEF DESCRIPTION OF THE FIGURES

FIG. 1 displays superimposed histograms from the flow cytometry analyses of erythrocytes collected from enhanced-GFP (eGFP)-expressing mice and a non-transgenic mouse. Erythrocytes from the non-transgenic BALB/c mice (8 weeks of age) emit a relatively small quantity of autofluorescence (Median Fluorescence Intensity (MFI)=25, “NT”) when compared to the fluorescence intensity of erythrocytes isolated from eGFP-expressing BALB/c mice at 24 weeks of age expressing one copy of the eGFP locus (MFI=2065, “Hemizygous”). The erythrocytes isolated from BALB/c hemizygotes exhibited approximately half the MFI of an age-matched homozygous eGFP-expressing SCID mouse (MFI=3656, “Homozygous”) that carried two copies of the locus.

FIG. 2 demonstrates that the erythrocytes isolated from young animals exhibited greater MFI than erythrocytes collected from older animals. The MFI of the erythrocyte population declined as the animals aged until the MFI stabilized after nine weeks of age. The stable MFI in mice older than 9-weeks of age indicates steady-state erythropoiesis with balanced quantities of nascent and senescent erythrocytes. Error bars represent the standard error of the mean (SEM).

FIG. 3 demonstrates that stress-induced erythropoiesis is clearly observable in mature eGFP-expressing mice. In this flow cytometry experiment, the gate was set to quantify the brightest 1% of the fluorescent erythrocytes that represented the youngest erythrocytes in circulation on day zero. Hemorrhage was induced on day zero and an elevation in erythropoiesis is evident one day later. Four days after hemorrhage, the animal exhibited significant erythropoiesis; nascent erythrocytes comprised a minor peak that constituted approximately 10% of the total erythrocytes in circulation. On day five, recently mobilized erythrocytes began to age and lose their fluorescence.

FIG. 4 shows that stress-induced erythropoiesis is readily quantifiable in mature eGFP-expressing mice. In response to hemorrhage, animals (n=5, “RO bleed”) produced a significant (P<0.05) increase in the number of circulating nascent erythrocytes; approximately 10% of the red cell mass had entered the circulation within 4 days of the hemorrhage. Animals that did not experience blood loss (n=5, “no treatment”) had no change in their steady-state erythropoiesis. Error bars represent the SEM.

FIG. 5 demonstrates eGFP fluorescence in erythrocytes from six different 1-year old BALB/c hemizygous mice one day prior to (FIG. 5A) and two days following (FIG. 5B) subcutaneous cobalt chloride (CoCl₂) injection. Upon CoCl₂ treatment, increased erythropoiesis was observed ranging from a 4-fold to an 18-fold increase in the eGFP fluorescence intensity from nascent erythrocytes.

FIG. 6 shows that treatment with an inhibitor of JAK2 kinase activity (VP444) blocks stress-induced erythropoiesis. Four days prior to an iatrogenic hemorrhage, blood (1 μL) was collected from vehicle-treated animals (n=5) as well as VP444-treated (20 mg/kg, twice a day orally for 5 days) animals (n=6) and erythrocytes were subjected to flow cytometry analyses to establish baseline of erythrocyte fluorescence intensity. VP444 treatment began 24-hours before an iatrogenic hemorrhage and was continued for five days. On day zero, animals were phlebotomized (approximately 200 μL) to stimulate erythrocyte production. On the days that followed the hemorrhage, tail vein blood was collected (1 μL) from each mouse for flow cytometry analyses. Three days after the iatrogenic hemorrhage, vehicle-treated animals experienced significant erythropoiesis; 11% of circulating red blood cells were nascent erythrocytes. In the VP444-treated group, no significant increase in erythropoiesis was observed on day three. However, significant erythropoiesis was observed in the VP444-treated group three days after the cessation of treatment. Error bars represent the SEM.

FIG. 7 shows that twenty-eight days of treatment with VP444 blocks EPO-mediated erythropoiesis in mice. When compared to vehicle-treated animals, VP444-treated (15 mg/kg, twice a day orally for 28 days) animals (n=3 per time point, n=6 for 28-day time point) had elevated concentrations of circulating EPO after seven days of treatment. By day twenty-eight, circulating EPO was approximately twenty-fold greater in VP444-treated animals when compared to vehicle-treated animals. Error bars represent the SEM.

FIG. 8 shows the detection of erythrocytes from eGFP-expressing mice following transfusion into non-transgenic mice. At day one, there was a detectable peak of eGFP-expressing erythrocytes within the population of erythrocytes isolated from the non-transgenic recipient mice following transfusion. Over time, a decrease in the number of eGFP-expressing erythrocytes was observed, as indicated by area under the curve of the high-intensity peak. Additionally, the left-shift of the high-intensity peak over time (as highlighted by the red arrow) demonstrates that eGFP fluorescence intensity decreases with the age of the transfused erythrocyte.

### DETAILED DESCRIPTION OF THE INVENTION

Throughout this application, various documents are referenced. Disclosures of these documents in their entireties are hereby incorporated by reference into this application.

Unless otherwise defined herein, scientific and technical terms used in connection with the present invention shall have the meanings that are commonly understood by those of ordinary skill in the art. Further, unless otherwise required by context, singular terms shall include pluralities and plural terms shall include the singular. Generally, nomenclatures used in connection with, and techniques of, cell and tissue culture, molecular biology, cell and cancer biology, virology, immunology, microbiology, genetics and protein and nucleic acid chemistry described herein are those well known and commonly used in the art.

The methods and techniques of the present invention are generally performed according to conventional methods well known in the art and as described in various general and more specific references that are cited and discussed throughout the present specification, unless otherwise indicated. See, e.g., Sambrook et al., Molecular Cloning: A Laboratory Manual, 2d ed., Cold Spring Harbor Laboratory Press, Cold Spring Harbor, N.Y. (1989); Ausubel at al., Current Protocols in Molecular Biology, Greene Publishing Associates (1992, and Supplements to 2003); Harlow and Lane, Antibodies: A Laboratory Manual, Cold Spring Harbor Laboratory Press, Cold Spring Harbor, N.Y. (1990); Coffin et al., Retroviruses, Cold Spring Harbor Laboratory Press; Cold Spring Harbor, N.Y. (1997); Bast at al., Cancer Medicine, 5th ed., Frei, Emil, editors, BC Decker Inc., Hamilton, Canada (2000); Lodish et al., Molecular Cell Biology, 4th ed., W. H. Freeman & Co., New York (2000); Griffiths at al., Introduction to Genetic Analysis, 7th ed., W. H. Freeman & Co., New York (1999); Gilbert et al., Developmental Biology, 6th ed., Sinauer Associates, Inc., Sunderland, Mass. (2000); and Cooper, The Cell—A Molecular Approach, 2nd ed., Sinauer Associates, Inc., Sunderland, Mass. (2000). All of the above and any other publications, patents and published patent applications referred to in this application are specifically incorporated by reference herein.

Throughout this specification, the word “comprise” or variations such as “comprises” or “comprising” will be understood to imply the inclusion of a stated integer or group of integers but not the exclusion of any other integer or group of integers.

The singular forms “a,” “an,” and “the” include plural reference unless the context clearly dictates otherwise.

The term “including” is used to mean “including but not limited to”. “Including” and “including but not limited to” are used interchangeably.

The term “agent” is used herein to denote a chemical compound (such as an organic or inorganic compound), a mixture of chemical compounds, a biological macromolecule (such as a nucleic acid, an antibody, a protein or portion thereof, e.g., a peptide, a lipid, a carbohydrate), or an extract made from biological materials such as bacteria, plants, fungi, or animal (particularly mammalian) cells or tissues. Agents include, for example, agents which are known with respect to structure and/or function, and those which are not known with respect to structure or function. The activity of such agents may render it suitable as a “therapeutic agent” which is a biologically, physiologically, or pharmacologically active substance (or substances) that acts locally or systemically in a subject. Agents can comprise, for example, drugs, metabolites, intermediates, cofactors, transition state analogs, ions, metals, toxins and natural and synthetic polymers (e.g., proteins, peptides, nucleic acids, polysaccharides, glycoproteins, hormones, receptors and cell surfaces such as cell walls and cell membranes). Agents may also comprise alcohols, alkyl halides, amines, amides, esters, aldehydes, ethers and other classes of organic agents.

A “subject”, or “individual” are used interchangeably and refer to a non-human animal. These terms include mammals, such as rodents (e.g., mice and rats). The term “mammalian subject” shall include, but is not limited to, mouse, rabbit, rat, guinea pig, hamster, or other rodents.

The terms “nucleic acid” and “polynucleotide” are used interchangeably. They refer to a polymeric form of nucleotides of any length, either deoxyribonucleotides or ribonucleotides, or analogs thereof. Polynucleotides may have any three-dimensional structure, and may perform any function, known or unknown. The following are non-limiting examples of polynucleotides: coding or non-coding regions of a gene or gene fragment, loci (locus) defined from linkage analysis, exons, introns, messenger RNA (mRNA), transfer RNA, ribosomal RNA, ribozymes, small interfering RNA (siRNA), micro RNA, cDNA, recombinant polynucleotides, branched polynucleotides, plasmids, vectors, isolated DNA of any sequence, isolated RNA of any sequence, nucleic acid probes, and primers. A polynucleotide may comprise modified nucleotides, such as methylated nucleotides and nucleotide analogs. If present, modifications to the nucleotide structure may be imparted before or after assembly of the polymer. The sequence of nucleotides may be interrupted by non-nucleotide components. A polynucleotide may be further modified, such as by conjugation with a labeling component. The term “recombinant” polynucleotide means a polynucleotide of genomic, cDNA, semi-synthetic, or synthetic origin which either does not occur in nature or is linked to another polynucleotide in a non-natural arrangement. The polynucleotide may be operatively linked to an “expression control sequence,” which refers to a nucleotide sequence that regulates the expression of a gene.

The terms “inhibiting erythropoiesis”, “suppressing erythropoiesis”, “decreasing erythropoiesis” or “reducing erythropoiesis” are used interchangeably and shall refer to either lessening, inhibiting or reducing erythrocyte production. It refers to the inhibition of steady-state erythrocyte production and altered erythrocyte production that may be due to, for example, blood loss, medical treatment, injury and disease.

The terms “inducing erythropoiesis”, “stimulating erythropoiesis” or “increasing erythropoiesis” are used interchangeably and shall refer to either the stimulation of erythrocyte production or to an erythropoietin-like activity. Agents that induce, stimulate, or increase erythropoiesis may be structurally or biologically similar to erythropoietin. It refers to the activation of steady-state erythrocyte production and altered erythrocyte production that may be due to, for example, blood loss, medical treatment, injury and disease.

The term “erythropoiesis” is used herein to denote the process of producing new erythrocytes. It includes intramedullary erythropoiesis and extramedullary erythropoiesis. It includes steady-state erythropoiesis and increased erythropoiesis due to, for example, blood loss, medical treatment, injury, or disease.

The term “fluorescent protein” (“FP”) is used herein to denote a protein that emits light at one particular wavelength when stimulated with light of a different particular wavelength. Fluorescent proteins include, for example, green fluorescent protein, blue fluorescent protein, yellow fluorescent protein, cyan fluorescent protein, red fluorescent protein and any variants thereof.

The term “modulator of erythropoiesis” is used herein to denote an agent that alters the production of erythrocytes. Modulators can stimulate or inhibit erythropoiesis. Alternatively, modulators can alter the site of erythropoiesis, for example, specifically up-regulating intramedullary or extramedullary erythropoiesis. Modulators can act in the absence of, synergize with, or oppose the actions of another agent or stimulus.

The term “endogenous” refers to a protein, a nucleic acid, a cell, or another molecule that originates from a source inside a subject.

The term “exogenous” refers to a protein, a nucleic acid, a cell, or another molecule that originates from a source outside of a subject. Non-limiting examples of exogenous molecules include: a recombinant protein, a plasmid, a virus, a cell from a donor subject, a tissue from a donor subject, an organ from a donor subject, or a synthetic chemical.

As used herein, the term “turnover” refers to the rate at which erythrocytes are replaced in circulating blood. It relates to the number of erythrocytes that are replaced over a given time period compared to the average number erythrocytes. Erythrocytes may be lost due to a number of factors, including but not limited to, senescence, phagocytosis and clearance in the spleen. Lost erythrocytes are replaced with nascent erythrocytes through erythropoiesis. The average lifespan of a erythrocyte in a mouse is 39 days (120 days for humans). Thus, over a 39 day period, a mouse undergoes 100% turnover of its erythrocytes, equaling a daily turnover of 2.5% (compared to a daily turnover of 1% in humans).

We developed a novel method for monitoring erythropoiesis by quantifying the fluorescence intensity of erythrocytes from GFP-expressing mice.

Our novel method utilizes animals containing a transgene expressing a fluorescent protein (FP), such as GFP, or a variant thereof. Because erythrocytes are anuclear and lack the organelles necessary to synthesize protein, we hypothesized that the initial levels of the FP or a variant thereof, in erythrocytes are at their maximal level. Since erythrocytes lack the ability to replace protein, including a FP or a variant thereof, which is lost through degradation over the lifetime of the cell, the FP protein concentrations and activities are highest in nascent erythrocytes and decrease through protein degradation with age. Thus, we hypothesized that an erythrocyte's age could be inversely correlated with FP level and activity.

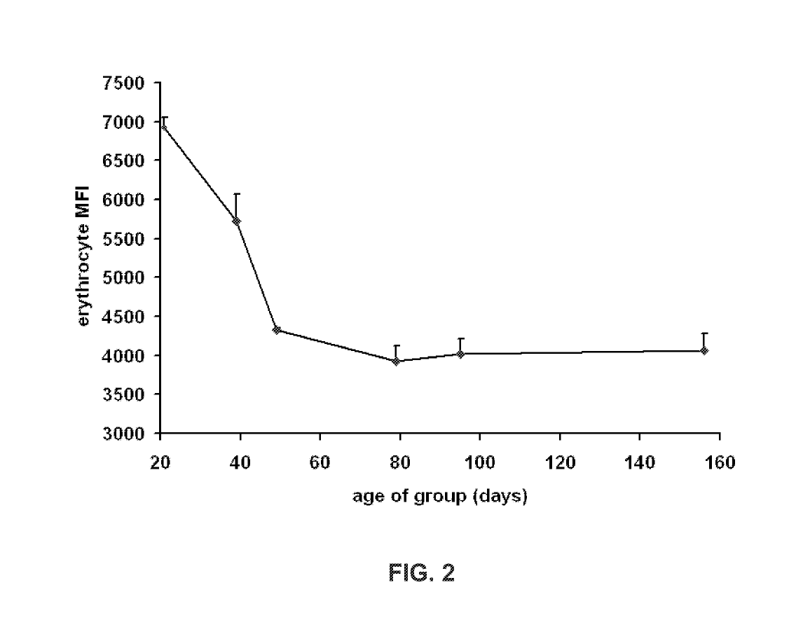

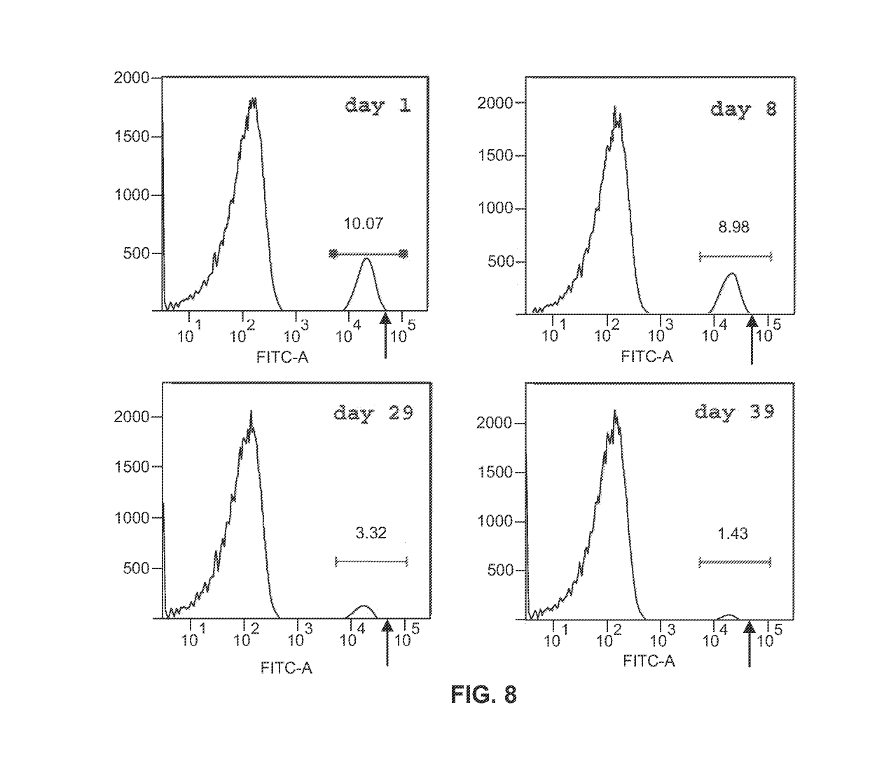

The data presented in Examples 2 and 7 confirm our hypothesis. FIG. 2 demonstrates that GFP fluorescence decreases with the age of a mouse until reaching a steady-state at 9 weeks of age. As young mice grow and develop, they undergo massive erythropoiesis to compensate for the increased demand of nutrients, which is indicated by the high level of GFP fluorescence in young mice. After 9 weeks of age, a steady-state of fluorescence is reached, indicating that erythropoiesis is occurring at the same rate as erythrocyte loss. Further evidence is provided in FIG. 8, which shows the experiment of GFP-expressing erythrocytes being transfused into a non-GFP recipient mouse. As such, no new GFP-expressing erythrocytes would he produced in the recipient mouse. Over time, a left-shift in the GFP curve was observed, indicating a decrease in erythrocytes with high levels of GFP and an increase in erythrocytes with low levels of GFP. The data confirm that GFP levels inversely correlate with erythrocyte age and support the use of our model of detecting erythrocyte age in vivo.

Our model for determining erythrocyte age can also be used to detect nascent erythrocytes, a marker of erythropoiesis. As discussed above, high levels of GFP correlated with high levels of erythropoiesis in young mice. As mice mature and reach 9 weeks of age, erythropoiesis approaches a steady state. Mice with steady-state erythropoiesis are useful for detecting changes in erythropoiesis associated with, for example, blood loss, pharmacological treatment, injury or disease.

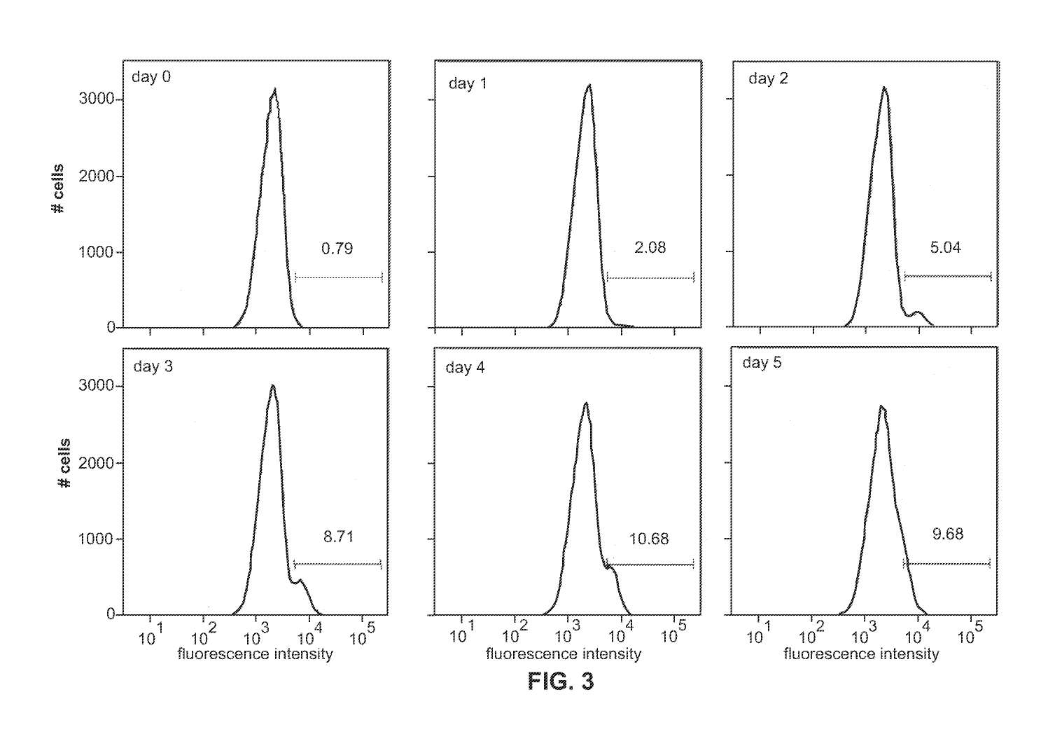

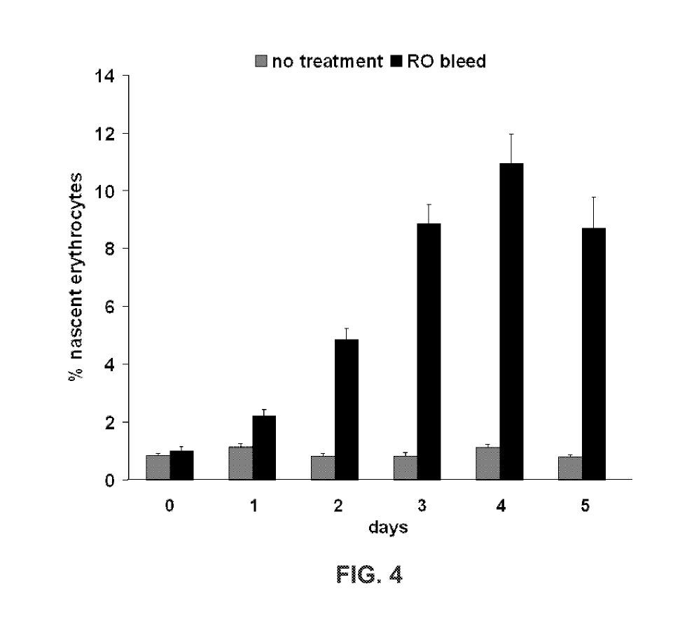

The data presented in Example 3 demonstrate that the method of the present invention is also useful for detecting nascent erythrocyte production in vivo associated with blood loss. Following a hemorrhage, erythropoiesis is up-regulated to compensate for the loss of erythrocytes, which is reflected in an increase in nascent erythrocytes. FIG. 3 demonstrates a right-shift in the GFP curve following a hemorrhage. This right shift represents an increase in high GFP-expressing erythrocytes, indicating an increase in nascent erythrocytes and, hence, erythropoiesis. FIG. 4 confirms this data and demonstrates that the observed increase in GFP expression occurs only after a hemorrhage and not after a sham procedure. The data confirm that the method of the present invention is useful for detecting nascent erythrocyte production in vivo, which correlates with erythropoiesis.

The data presented in Example 7 demonstrate that the method of the present invention is also useful for detecting erythrocyte turnover in vivo. Transfusion of GFP-expressing erythrocytes into non-transgenic mice, as shown in FIG. 8, results in a diverse population erythrocytes ranging in maturity from nascent to senescent. Because the recipient mice are non-transgenic, no GFP-expressing nascent erythrocytes are produced. Over time, the GFP-expressing erythrocyte population ages and dies off. These changes in the aging and senescent GFP-erythrocytes can be directly quantitated based on the fluorescent intensities of GFP. Additionally, the fluorescent protein may be operatively linked to an inducible promoter to study erythrocyte turnover in pulse-chase experiments.

The methods of the present invention can also be used to segregate erythrocytes into distinct populations based on age, for example, distinct nascent and senescent populations. These isolated populations can be further examined to determine characteristics unique to each population, including, for example, cell surface markers, intracellular markers, metabolic changes, active signaling pathways, hemoglobin content, cell shape, and cell size.

Accordingly, one embodiment of the invention relates to a method for detecting nascent erythrocyte production in vivo comprising the steps of: (a) obtaining one or more blood samples from a subject, the subject comprising a fluorescent protein (FP); (b) determining a protein or activity level of the FP in erythrocytes from one or more samples; (c) comparing the protein or activity level of the FP in the one or more samples to a protein or activity level of a control FP, wherein an increase in the protein or activity level of the FP in the one or more samples compared to the control is indicative of nascent erythrocyte production in vivo in the subject.

In another embodiment, the invention relates to a method for detecting erythrocyte age in vivo comprising the steps of: (a) obtaining one or more blood samples from a subject, the subject comprising a fluorescent protein (FP); (b) determining the protein or activity level of the FP in erythrocytes from one or more samples; (c) comparing the protein or activity level of the FP in the one or more samples to a protein or activity level of a control FP, wherein a decrease in the protein or activity level of the FP in the one or more samples compared to the control is indicative of an increase in erythrocyte age in vivo in the subject.

In yet another embodiment, the invention relates to a method for detecting erythrocyte turnover in vivo comprising the steps of: (a) obtaining one or more blood samples from a subject, the subject comprising a fluorescent protein (FP); (b) determining the protein or activity level of the FP in erythrocytes from one or more samples; (c) comparing the protein or activity level of the FP in the one or more samples to a protein or activity level of a control FP, wherein an change in the protein or activity level of the FP in the one or more samples compared to the control is indicative of a change in erythrocyte turnover in vivo in the subject.

The methods of the present invention utilizes subjects that comprise a fluorescent protein (FP), including, for example a GFP, a BFP, a CFP, a YFP, a RFP or any variant, thereof. In certain embodiments, the subject comprises GFP. Non-limiting sources for GFP include Aequorea victoria and Renilla reniformis. Fluorescent proteins may be wild-type or engineered to enhance a certain characteristic, including, but not limited to, increased fluorescence, photostability, a shift of the major excitation peak to 488 nm, folding efficiency, pH sensitivity, redox sensitivity, cellular localization, and color. Various color mutants include: blue fluorescent protein (EBFP, EBFP2, Azurite, mKalama1), cyan fluorescent protein (ECFP, Cerulean, CyPet) and yellow fluorescent protein derivatives (YFP, Citrine, Venus, YPet). Additionally, red fluorescent protein has been isolate from the sea anemone. In some embodiments, the subject may comprise non-fluorescent marker proteins.

In some embodiments, the subjects comprising a FP, a variant thereof, or non-fluorescent marker protein are generated by transgenesis. In some embodiments, the transgenic subjects constitutively and ubiquitously express a FP, a variant thereof, or a non-fluorescent marker protein. In other embodiments, the transgenic subjects express a FP, a variant thereof, or a non-transgenic marker protein in a temporally-restricted, developmentally-restricted, tissue-specific, inducible, or conditional manner. Methods of transgenesis, including gene targeting and homologous recombination, are well-known in the art.

In some embodiments, the subject comprises a FP derived from exogenous cells. The subject may acquire the exogenous cells through procedures such as blood transfusion and xenograft transplantation. In some embodiments, the exogenous cells originate from a donor, wherein the endogenous cells of the donor comprise a FP.

Additionally, nucleic acids comprising a sequence encoding a FP, a variant thereof, or a non-fluorescent marker protein may be introduced into selected host cells and host subjects by well-known methods. The methods include, but are not limited to, transfection, viral delivery, protein or peptide mediated insertion, coprecipitation methods, lipid based delivery reagents (lipofection), cytofection, lipopolyamine delivery, dendrimer delivery reagents, electroporation or mechanical delivery.

In certain embodiments of the invention, the control protein or activity level is the FP protein or activity level in erythrocytes in a blood sample from the subject prior to obtaining the samples to be tested.

In certain embodiments of the invention, the subject has suffered a condition selected from blood loss, injury, and disease. In some embodiments the disease is polycythemia vera. Blood loss refers to the loss of blood from the circulatory system. In some embodiments, the blood loss is external, i.e., blood exits the body through a natural opening or break in the skin. In other embodiments, the blood loss is internal, e.g. internal bleeding, contusion, or hematoma. In some embodiments, the blood loss impairs the delivery of nutrients to and the removal of waste from tissues. In some embodiments, the blood loss is sufficient to stimulate erythropoiesis. In certain embodiments of the invention, the blood loss is associated with a condition selected from the group consisting of hemorrhage, acute blood loss, menstruation, anemia, hemophilia, hematoma, contusion, aneurysm, arteriovenous malformation, ulcerations, cancer, infection, thalassemia, Evans syndrome, spherocytosis and von Willebrand disease. In certain embodiments of the invention, the anemia is associated with a condition selected from the group consisting of chronic renal failure, end-stage renal disease, renal transplantation, cancer, acquired immune deficiency syndrome, chemotherapy, radiotherapy, bone marrow transplantation, prematurity, aplastic anemia, Fanconi anemia, hemolytic anemia, hereditary spherocytosis, sickle-cell anemia, auto-immune disease, pernicious anemia, myelophthisic anemia, pregnancy, Heinz body anemia, dimorphic anemia, normocytic anemia, macrocytic anemia, and microcytic anemia.

In certain embodiments of the invention, the blood sample from the subject is obtained repeatedly over time. For example, the blood sample may be obtained every day, every 2 days, every 3 days, semiweekly, weekly, semimonthly, or monthly.

Blood may be obtained from a subject in a single bolus or repeatedly over time. In some embodiments, blood is obtained intravenously. In some embodiments, blood is obtained by retro-orbital bleed. In some embodiments, the blood is obtained from a tail-snip. In some embodiments, blood is obtained from a pin-prick. In some embodiments, blood is collected from a minute incision in the lateral tail vein. In certain embodiments, the blood collection procedure is terminal. For example, the terminal procedure may be a cardiac puncture.

In certain embodiments of the invention, the subject is a mammal. The mammal may be a mouse, rat, rabbit, or guinea pig. In certain embodiments of the invention, the mammal is a mouse. In some embodiments, the subject is a healthy subject with steady-state erythropoiesis. In other embodiments, the subject has altered erythropoiesis. In some embodiments, the altered erythropoiesis is due to stress-induced erythropoiesis. In some embodiments, the stress-induced erythropoiesis is due to blood loss.

In certain embodiments of the invention, the determination of protein or activity level of he FP utilizes an assay for measuring the FP fluorescence level. FP fluorescence is stimulated by exposure to light at certain excitation wavelengths. For example, GFP is stimulated at an excitation wavelength of 395 nm and emits light at an emission wavelength of 509 nm. Other FP variants with alternate excitation and emission wavelengths are also well-known in the art for example, enhanced GFP is excited at 488 nm. The FP fluorescence varies directly with FP protein levels, such that FP fluorescence provides a quantitative measure of protein levels. FPs are minimally toxic to cells or organisms, and are ideally suited for both in vitro and in vivo measurement.

In certain embodiments of the invention, the assay measures the FP fluorescence level using flow cytometry. Flow cytometry utilizes scattered light to determine the characteristics (size and composition) of a cell and fluorescence to detect the presence of a cellular marker. Forward scatter correlates with cell volume, while side scatter correlates with cell complexity (e.g., shape of nucleus and organelle composition). The combination of forward and side scattering can be used to isolate distinct cell types from a population of cells. In some embodiments of the invention, forward and side scatter measurements are used to isolate erythrocytes. In certain embodiments of the invention, the flow cytometry is fluorescence activated cell sorting (FACS).

In other embodiments of the invention, the assay measures the FP fluorescence level using fluorescent microscopy. The fluorescent microscopy may be quantitative fluorescent microscopy or scanning fluorescent microscopy.

The present invention also relates to a method for identifying a modulator of erythropoiesis comprising the steps of: (a) exposing a test subject comprising a fluorescent protein (FP) to a test agent; (b) detecting a presence or absence of a change in protein or activity level of the in erythrocytes in the test subject compared to a subject not exposed with the test agent; wherein the presence of a change in the protein or activity level of the FP indicates that the test agent is a modulator of erythropoiesis.

The test agent may be a small molecule, a chemical moiety, a polynucleotide, a polypeptide, or an antibody. Small molecules include, for example, biologically active organic compounds that are not polymers. Small molecules may be naturally occurring or synthetic. In some embodiments, the small molecules of the present invention modulate the erythropoietin pathway. In some embodiments, the small molecules of the present invention inhibit the signaling pathway of EPO. For example, the small molecule can inhibit Janus Kinase 2 (JAK2), one of the downstream effectors of the EPO pathway. The data presented in Example 5 demonstrate that treatment with a small molecule JAK2 inhibitor (VP444) reversibly inhibits erythropoiesis following blood loss.

Chemical moieties can also modulate erythropoiesis. For example, the data presented in Example 4 demonstrate that cobalt chloride, a chemical moiety, can be used to stimulate erythrocyte production in vivo.

Polynucleotides can also be used to modulate erythropoiesis. For example, nucleotides expressing candidate genes, novel genes or mutants thereof can be tested for their ability to modulate erythropoiesis. Alternatively, siRNA molecules directed towards a candidate or novel gene can be used to test said gene's ability to modulate erythropoiesis. Mice expressing these nucleotides or siRNA molecules as transgenes can be crossed to mice expressing a FP transgene. The erythropoiesis in the double transgenic mice can be compared to the erythropoiesis in mice expressing only the FP transgene. For instance, a polynucleotide encoding erythropoietin may be used to stimulate erythropoiesis, while an siRNA molecule that knocks-down erythropoietin may be used to inhibit erythropoiesis.

Polypeptides, peptide hormones or mutants thereof may also regulate erythropoiesis. Recombinant candidate, novel, or mutant polypeptides can be injected into mice expressing a FP transgene to determine the effect of the polypeptide on erythropoiesis. For example, recombinant erythropoietin, or variants thereof, may be used to increase or decrease erythropoiesis. Additionally, the polypeptide may be an antibody that neutralizes a candidate or novel polypeptide, For example, erythropoietin-neutralizing antibodies may be used to inhibit erythropoiesis.

Any modulators identified by the any of the above described methods are also encompassed as an embodiment encompassed within the invention. In some embodiments, the method of using a modulator that is identified by any of the above described methods to modulate erythropoiesis is encompassed as an embodiment of the invention.

The present invention also relates to a method for determining the efficacy of an agent in inhibiting erythropoiesis in vivo comprising the steps of: (a) exposing a test subject comprising a fluorescent protein (FP) to a test agent; (b) detecting the protein or activity level of the FP in erythrocytes in the test subject and the protein or activity level of the FP in erythrocytes in a subject comprising a fluorescent protein in the absence of the test agent; wherein a reduction in the protein or activity level of the FP in the presence of the test agent compared to the protein or activity level of the FP in the absence of the test agent indicates that the test agent is effective in inhibiting erythropoiesis.

The present invention also relates to a method for determining the efficacy of an agent in inducing erythropoiesis in vivo comprising the steps of: (a) exposing a test subject comprising a fluorescent protein (FP) to a test agent; (h) detecting the protein or activity level of the FP in erythrocytes in the test subject and the protein or activity level of the FP in erythrocytes in a subject comprising a fluorescent protein in the absence of the test agent; wherein an increase in the protein or activity level of the FP in the presence of the test agent compared to the protein or activity level of the FP in the absence of the test agent indicates that the test agent is effective in inducing erythropoiesis.

The test agent may be a small molecule, a chemical moiety, a polynucleotide, a polypeptide, or an antibody. In certain embodiments of the invention, the test agent inhibits the erythropoietin signaling pathway. As discussed in Example 5, a small molecule inhibitor of JAK2, a downstream effector of the EPO pathway, is able to reversibly inhibit erythropoiesis following blood loss. Thus, in certain embodiments of the invention, the test agent inhibits the Janus Kinase 2 (JAK2) signaling pathway.

In other embodiments of the invention, the test agent induces the erythropoietin signaling pathway. As discussed in Example 4, subcutaneous injection of cobalt chloride stimulates erythropoiesis in vivo.

The present invention further relates to a method for identifying a modulator of erythropoiesis-related disease comprising the steps of (a) exposing a test subject suffering from a erythropoiesis-related disease to a test agent, said test subject comprising a fluorescent protein (FP); (b) detecting a presence or absence of a change in protein or activity level of the FP in erythrocytes in the test subject compared to a subject suffering from the erythropoiesis-related disease but not exposed to the test agent; wherein the presence of a change in the protein or activity level of the FP indicates that the test agent is a modulator of the erythropoiesis-related disease, in some embodiments, the test subject comprises an animal model of a human disease. In further embodiments, the test subject is a mouse, rabbit, rat, guinea pig, hamster, or other non-human mammal.

The following examples are meant to illustrate the methods and materials of the present invention. Suitable modifications and adaptations of the described conditions and parameters normally encountered in the art are within the spirit and scope of the present invention.

### EXAMPLE 1

### Detection of eGFP Expression in Erythrocytes of eGFP-Expressing Mice

Tail vein blood (1 μl) was collected from non-transgenic BALB/c mice (8 weeks old), BALB/c mice hemizygous for an enhanced-GFP (eGFP) transgene (24 weeks old), and SCID mice homozygous for the same eGFP transgene (24 weeks old).

Mice were anesthetized with isofluorane and a minute incision was made into the lateral tail vein. Approximately 1 μl of tail vein blood was diluted into 0.5 ml of sterile saline containing 3 mM EDTA and stored at 4° C. Fluorescence activated cell sorting (FACS) was performed within 6 hours of blood collection on a FACSAria (BD Biosciences, San Jose, Calif.) flow cytometer. A 488 nm laser was used to excite the eGFP and a 530/30 nm band-pass filter and a 502 nm long-pass filter were used to monitor emissions. Forward and side scatter were used to gate for single erythrocytes, with approximately one hundred thousand events measured per blood sample. Median Fluorescence Intensity (MFI) for each erythrocyte population was analyzed using FlowJo 7.2.5 software (Tree Star, Inc. Ashland, Oreg.).

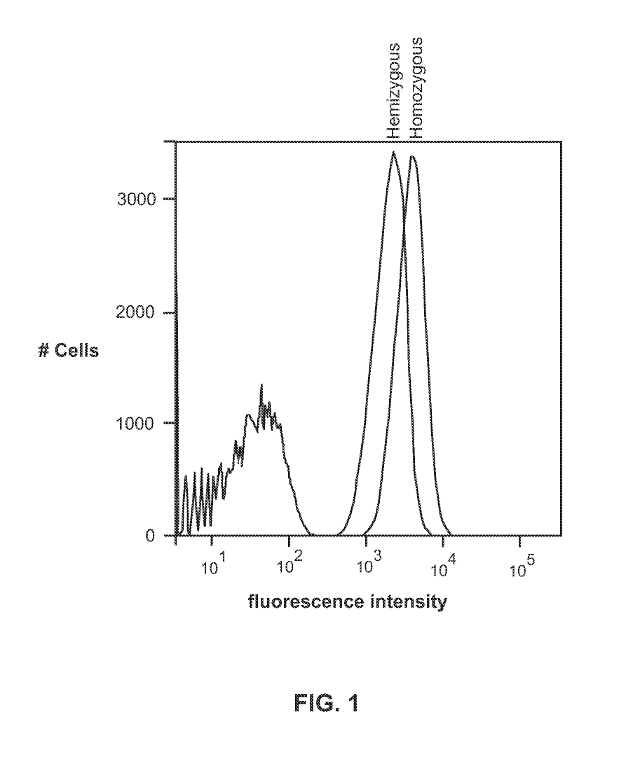

FIG. 1 shows the histograms from the FACS analysis of the non-transgenic (NT), hemizygous and homozygous mice. Erythrocytes from the non-transgenic (NT) mice emit low levels of autofluorescence (MFI=25). Hemizygous mice emitted more than 80-fold higher levels of eGFP fluorescence (MFI=2065), while homozygous mice emitted almost 150-fold higher levels (MFI=3656).

The correlation between gene copy number (2-fold increase from hemizygous to homozygous) and median fluorescence intensity (1.8-fold increase from hemizygous to homozygous) demonstrates that this method is useful for specific and quantitative analysis of eGFP levels in erythrocytes.

### EXAMPLE 2

### eGFP Levels in Erythrocytes Decreases as a Mouse Ages

Tail vein blood (1 μl) was collected as described in Example 1 from SCID mice homozygous for the eGFP transgene at various ages: 21, 39, 49, 79, 95, and 156 days old. eGFP levels were analyzed and the MFI of each population was quantified as described in Example 1.

FIG. 2 demonstrates that erythrocytes isolated from young mice exhibited higher eGFP levels (indicated by MFI) than erythrocytes isolated from older mice. The eGFP levels decreased with age until leveling off after nine weeks of age. The steady-state levels in mice older than nine weeks indicates a balance between nascent and senescent erythrocytes.

The correlation between fluorescence intensities and the age of the mice demonstrates that this method is useful in quantifying erythrocyte age in vivo.

### EXAMPLE 3

### Detection of Stress-Induced Erythropoiesis in eGFP Mice Following Hemorrhage

Iatrogenic hemorrhage was induced in 24-week old female hemizygous BALB/c mice by collection of approximately 200 μl of retro-orbital blood. An age-matched sham-treated group was used as a control. Tail vein blood (1 μl) was collected daily starting on the same day as the retro-orbital bleed (Day 0) as described in Example 1, eGFP levels were analyzed and the MFI of each population was quantified as described in Example 1.

FIG. 3 demonstrates the eGFP fluorescence in the erythrocytes of a mouse for five days following retro-orbital bleed. Elevation in erythropoiesis is evident as early as Day 1, indicated by the right-shift in the fluorescence distribution curve. Maximum erythropoiesis occurred on Day 4, when the nascent erythrocytes comprised 10% of the total erythrocytes in circulation. On Day 5, recently mobilized erythrocytes began to age and lose fluorescence, returning to a steady-state turnover of erythrocytes.

FIG. 4 summarizes the erythropoiesis in both the hemorrhage (RO bleed) and sham-treated (no treatment) populations of mice. The hemorrhage population of mice demonstrated a significant increase in the number of circulating nascent erythrocytes, up to 10% of the total circulating erythrocytes. The sham-treated population of mice exhibited no change in their steady-state turnover of erythrocytes. Taken together, these data indicate that the method of the present invention is an effective tool for monitoring in vivo changes in erythropoiesis.

### EXAMPLE 4

### Detection of Cobalt Chloride-Induced Erythropoiesis in eGFP Mice

The effect of cobalt chloride on erythropoiesis was evaluated in this study. Cobalt chloride has traditionally been used to treat anemia in pregnant women, infants, and patients with chronic anemia undergoing long term hemodialysis. It induces hypoxia-like responses, such as erythropoiesis and angiogenesis in vivo, by activating HIF1-alpha, which increases expression of erythropoietin.

Tail vein blood (1 μl) was collected daily from one-year old hemizygous BALB/c mice starting on the day before cobalt chloride treatment (Day −1) and continuing through three days after treatment (Day 3) as described in Example 1, On Day 0, six one-year old BALB/c (hemizygous) mice were subcutaneously injected with 0.1 mL saline containing 4 μmols of cobalt chloride. FACS was performed immediately following the blood draw, and data were analyzed with FlowJo software as described in Example 1.

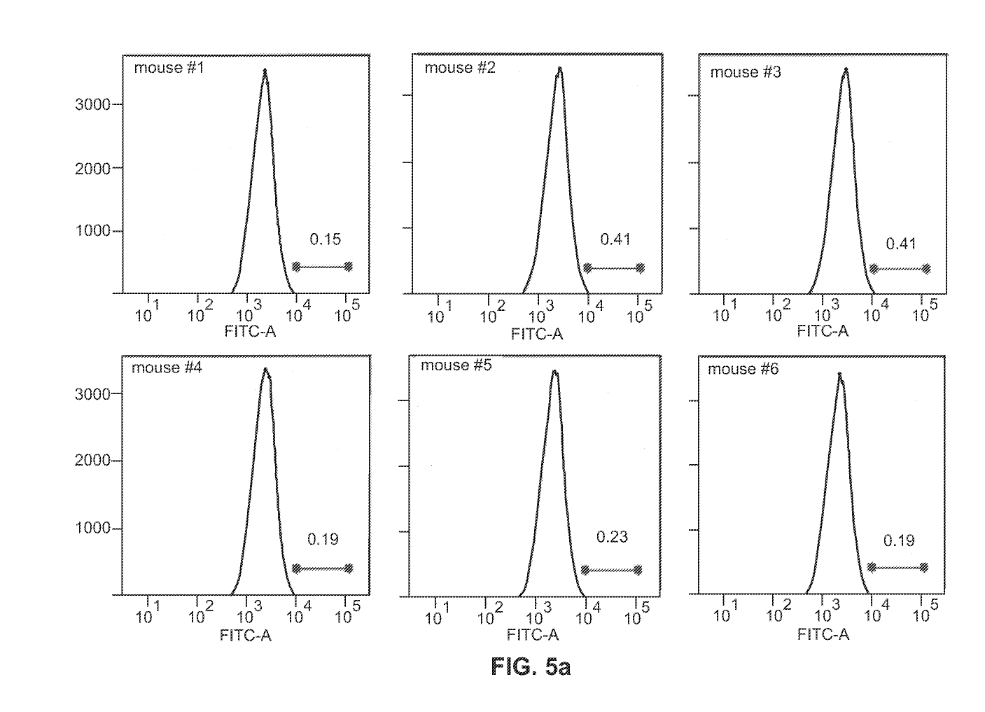

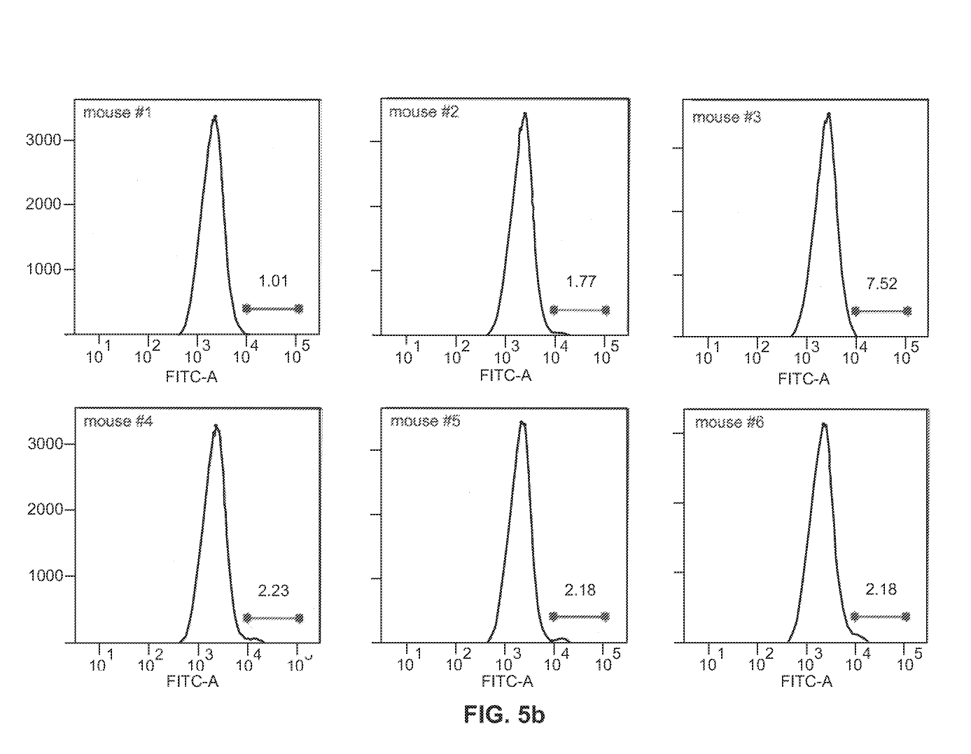

FIG. 5 demonstrates eGFP fluorescence in pre-treated (Day −1, FIG. 5A) and cobalt chloride treated (Day 2, FIG. 5B) mice. Cobalt chloride stimulated erythropoiesis in each of the six mice tested, as indicated in the right-shift of the eGFP fluorescence curves. A statistically significant 10-fold increase in the number of nascent erythrocytes was observed following cobalt chloride treatment. The data indicate that the method of the present invention is suited for determining the efficacy of erythropoietic stimulators in vivo.

### EXAMPLE 5

### Determining the Efficacy of Erythropoiesis Modulators in eGFP Mice

Twenty-four week old hemizygous BALB/c female mice were orally treated twice a day with either a vehicle or a JAK2 inhibitor, VP444 (20 mg/kg). On the second day of treatment, iatrogenic hemorrhage was induced as described in Example 3. Tail vein blood (1 μl) was collected daily, as described in Example 1, starting on the same day as the retro-orbital bleed (Day 0). eGFP levels were analyzed and the MFI of each population was quantified as described in Example 1.

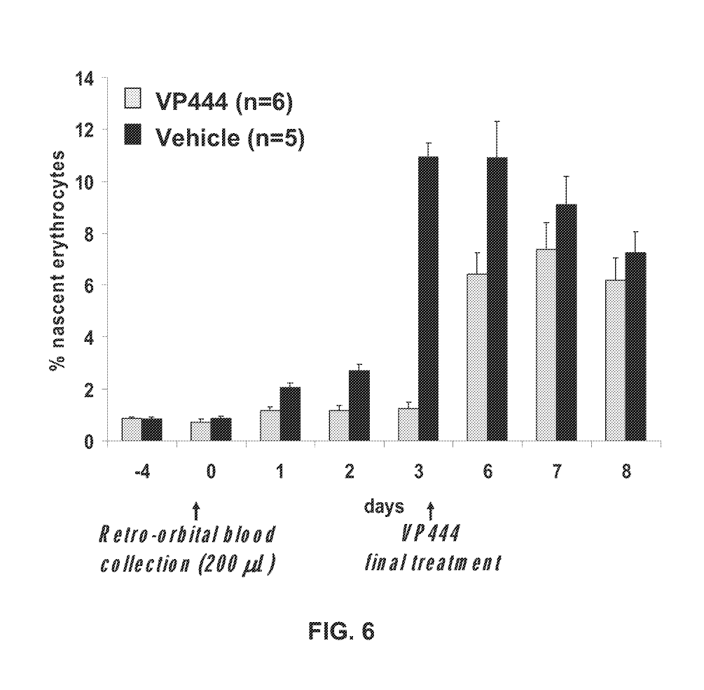

FIG. 6 summarizes the erythropoiesis in both vehicle-treated and VP444-treated mice. Vehicle treated mice demonstrated a significant increase in erythropoiesis, resulting in an increase of nascent erythrocytes up to 11% of the total circulating erythrocyte population. No significant increase in erythropoiesis was observed during the first three days following hemorrhage in VP444-treated mice. However, when VP444 treatment was stopped three days after hemorrhage, an increase in erythropoiesis was observed following withdrawal of the treatment in the VP444-treated mice. The data demonstrate that the method of the present invention is an effective tool for determining the efficacy of modulators of erythropoiesis.

### EXAMPLE 6

### Monitoring the Effect of Extended VP444 Treatment on EPO-Mediated Erythropoiesis

Six week old BALB/c non-transgenic mice were orally treated with VP444 (15 mg/kg) or vehicle twice a day over twenty-eight days. Terminal blood was obtained from mice on days 7, 10, 14, and 28. Plasma was isolated from the terminal blood and erythropoietin (EPO) was quantified using the murine EPO QuantiKine kit (R&D Systems, Minneapolis, Minn.), according to the manufacturer's instructions. Hematocrit was also determined for the 28-day terminal blood sample using the VetABC automated blood counter (Skil, Boulder, Colo.) according the manufacturer's instructions.

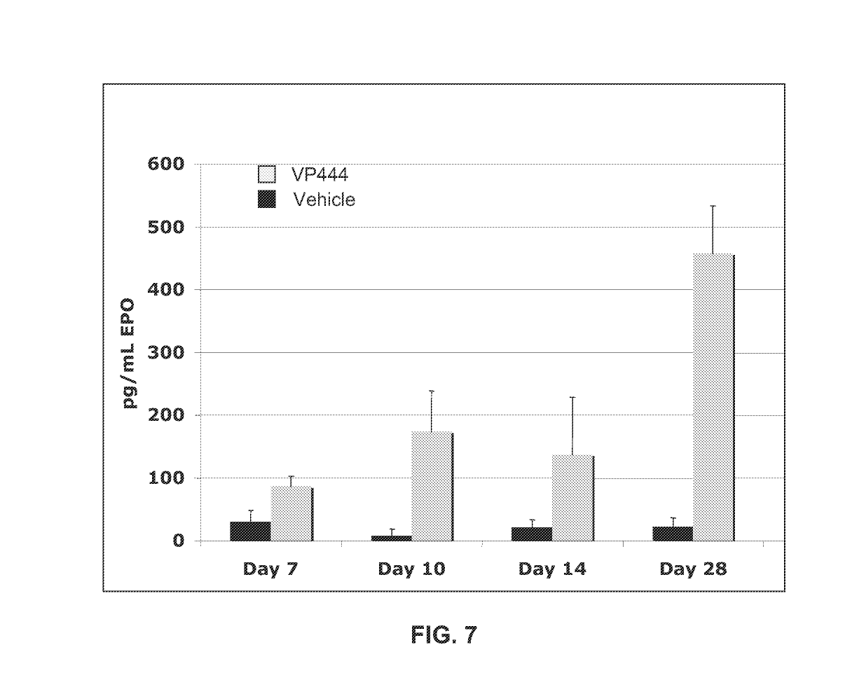

FIG. 7 demonstrates the EPO levels observed in the terminal blood of vehicle and VP444-treated mice over the twenty-eight day time course. EPO levels were elevated in the VP444-treated mice at every timepoint, reaching a maximum 20-fold increase on Day 28. These data confirm that VP444 inhibits erythropoiesis and demonstrate that the site of inhibition is downstream of EPO. This correlates with VP444's ability to inhibit the kinase activity of Janus Kinase 2, a downstream effector of EPO.

### EXAMPLE 7

### Monitoring Erythrocyte Survival Following Blood Transfusion

Blood (0.4 mL) was collected from four-month old eGFP-expressing SCID mice by terminal cardiac puncture into a 1 mL syringe containing 50 μl 0.5 mM EDTA. Erythrocytes were recovered and washed twice with sterile saline (0.9%). The washed erythrocytes were resuspended in 0.5 mL sterile saline, and 200 μL of the washed erythrocytes were intravenously injected in 8-week old female SCID mice on Day 0. Tail vein blood (1 was collected, as described in Example 1, on Day 1, Day 8, Day 29, and Day 39 following transfusion. eGFP levels were analyzed and the MFI of each population was quantified as described in Example 1.

FIG. 8 demonstrates the turnover of eGFP-expressing erythrocytes following transfusion into a non-transgenic mouse. The low-intensity (left hand) peak demonstrates the autofluorescence detected from the non-transgenic erythrocytes, while the high-intensity (right hand) peak demonstrates the eGFP-expressing erythrocytes introduced by transfusion. With time, the area under the high-intensity peak decreases, indicating the turnover of the eGFP-expressing erythrocytes. Thirty-nine days after transfusion, approximately 98% of the transfused eGFP-expressing erythrocytes were no longer detected, which confirms the published 39-day lifespan of a erythrocyte. The left-shift of the high-intensity peak over time confirms that eGFP-intensity decreases with the age of the erythrocyte, indicating an inverse correlation between eGFP-intensity and erythrocyte age.

1. A method for detecting nascent erythrocyte production in vivo comprising the steps of:
(a) obtaining one or more blood samples from a subject, said subject comprising a fluorescent protein;
(b) determining a protein or activity level of said fluorescent protein in erythrocytes from said one or more samples;
(c) comparing the protein or activity level of said fluorescent protein in said one or more samples to a protein or activity level of a control fluorescent protein,
wherein an increase in the protein or activity level of said fluorescent protein in said one or more samples compared to said control is indicative of nascent erythrocyte production in vivo in said subject.

2. A method for detecting erythrocyte age in vivo comprising the steps of:
(a) obtaining one or more blood samples from a subject, said subject comprising a fluorescent protein;
(b) determining a protein or activity level of said fluorescent protein in erythrocytes from said one or more samples;
(c) comparing the protein or activity level of said fluorescent protein in said one or more samples to a protein or activity level of a control fluorescent protein,
wherein a decrease in the protein or activity level of said fluorescent protein in said one or more samples compared to said control is indicative of an increase in erythrocyte age in vivo in said subject.

3. A method for detecting erthrocyte turnover in comprising the steps of:
(a) obtaining one or more blood samples from a subject, said subject comprising a fluorescent protein;
(b) determining a protein or activity level of said fluorescent protein in erythrocytes from said one or more samples;
(c) comparing the protein or activity level of said fluorescent protein in said one or more samples to a protein or activity level of a control fluorescent protein,
wherein a change in the protein or activity level of said fluorescent protein in said one or more samples compared to said control is indicative of a change in erythrocyte turnover in vivo in said subject.

4. The method of any one of claims 1-3, wherein said fluorescent protein is selected from the group consisting of green fluorescent protein (GET), blue fluorescent protein (BFP), cyan fluorescent protein (CFP), yellow fluorescent protein (YFP), and red fluorescent protein (RFP).

5. (canceled)

6. The method of any one of claims 1-3, wherein said fluorescent protein is expressed by a nucleic acid operatively linked to an expression control sequence.

7. The method of any one of claims 1-3, wherein said subject has suffered a condition selected from the group consisting of blood loss, injury, and disease.

8. The method of any one of claims 1-3, wherein said control protein or activity level is the fluorescent protein or activity level in erythrocytes in a control blood sample from said subject prior to obtaining said one or more blood samples.

9. The method of any one of claims 1-3, wherein said one or more blood samples from said subject are obtained repeatedly over time.

10. The method of claim 7, wherein said blood loss is associated with a condition selected from the group consisting of hemorrhage, acute blood loss, menstruation, anemia, hemophilia, hematoma, contusion, aneurysm, arteriovenous malformation, ulcerations, cancer, infection, thalassemia, Evans syndrome, spherocytosis and von Willebrand disease.

11-12. (canceled)

13. The method of any one of claims 1-3, wherein said subject is a mammal.

14. The method of claim 13, wherein said mammal is a mouse, rat, rabbit, or guinea pig.

15. (canceled)

16. The method of any one of claims 1-3, wherein said determining step utilizes an assay for measuring the fluorescence level of the fluorescent protein, wherein said assay measures the fluorescence level of the fluorescent protein using flow cytometry, fluorescent microscopy, quantitative fluorescent microscopy or scanning fluorescent microscopy.

17. (canceled)

18. The method of claim 16, wherein said flow cytometry is fluorescent activated cell sorting (FACS).

19. (canceled)

20. The method of claim 2 or 3, wherein said subject comprises said fluorescent protein derived from exogenous cells.

21. A method for identifying a modulator of erythropoiesis comprising the steps of:
(a) exposing a test subject comprising a fluorescent protein to a test agent;
(b) detecting a presence or absence of a change in the protein or activity level of said fluorescent protein in erythrocytes in said test subject compared to a subject comprising a fluorescent protein not exposed with the test agent;
wherein the presence of a change in said protein or activity level of said fluorescent protein indicates that said test agent is a modulator of erythropoiesis.

22-38. (canceled)

39. A method for determining the efficacy of an agent in inhibiting erythropoiesis in vivo comprising the steps of:
(a) exposing a test subject comprising a fluorescent protein to a test agent;
(b) detecting a protein or activity level of said fluorescent protein in erythrocytes in said test subject and a protein or activity level of said fluorescent protein in erythrocytes in a subject comprising a fluorescent protein in the absence of said test agent;
wherein a reduction in said protein or activity level of said fluorescent protein in the presence of said test agent compared to said protein or activity level of said fluorescent protein in the absence of said test agent indicates that the test agent is effective in inhibiting erythropoiesis.

40-55. (canceled)

56. The method of claim 39, wherein said test agent inhibits the erythropoietin signaling pathway.

57. The method of claim 39, wherein said test agent inhibits the Janus Kinase 2 (JAK2) signaling pathway.

58. A method of determining the efficacy of an agent in inducing erythropoiesis in vivo comprising the steps of:
(a) exposing a test subject comprising a fluorescent protein to a test agent;
(b) detecting a protein or activity level of said fluorescent protein in erythrocytes in said test subject and a protein or activity level of said fluorescent protein in erythrocytes in a subject comprising a fluorescent protein in the absence of said test agent;
wherein an increase in said protein or activity level of said fluorescent protein in the presence of said test agent compared to said protein or activity level of said fluorescent protein in the absence of said test agent indicates that the test agent is effective in inducing erythropoiesis.

59. The method of any one of claims 21, 39 and 58, wherein said protein or activity level of said fluorescent protein in erythrocytes is monitored by obtaining one or more blood samples.

60-73. (canceled)

74. The method of any one of claims 21, 39 and 58, wherein said test agent is a small molecule, a chemical moiety, a polynucleotide, a polypeptide, or an antibody.

75. The method of claim 58, wherein said test agent induces the erythropoietin signaling pathway.
